(19) United States
(12) Patent Application Publication
(10) Pub. No.: US 2006/0023766 A1
(43) Pub. Date: Feb. 2, 2006

(54) Measuring device for a heat flux

(76) Inventor: Jean-Claude Padoy, Valeyres-sous-Montagny (CH)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/534,730

(22) PCT Filed: Nov. 11, 2003
(86) PCT No.: PCT/CH03/00735

§ 371 Date: May 12, 2005

(30) Foreign Application Priority Data
Nov. 13, 2002 (FR) 02/14174

(51) Int. Cl. G01K 17/00

(52) U.S. Cl. 374/29

(57) ABSTRACT

The invention device (100) for controlling combustion gases and the thermokinetic characteristics of thermal and chemical reactions of all processes comprises a tubular metallic body (1) which is closed on the ends thereof with a plug (2) provided with an input and output (8,9) and a cap (3) containing a metallic lens (11) arranged therein, the lens having a high thermal diffusivity and one of the faces (12) thereof contacting gaseous fluid (22). An isotropic chamber (5) for measuring a radiative flux is disposed inside the metallic body (1), and a heat flux sensor (20) is fixed on the median plane of the isotropic chamber (5).

### TECHNICAL FIELD

The present invention concerns a device for measuring a non-stationary radiating and convective heat flux generated within a gaseous fluid, notably a highly corrosive gaseous fluid under high pressure and at high temperature such as a gas resulting from the combustion of propellants.

### PRIOR TECHNIQUE

Various systems are known for measuring heat flux. One of these systems is described in the article “Integral Plug-Type Flux Gauge” in NTS TECH NOTES, US Department of Commerce, Springfield, Va., US, 1992, page 34, 1-2, XP000287850 ISSN: 0889-8464 and concerns a flux meter, based on the utilization of thermocouples which measure the flux of heat in contact with a sample of material and by effecting a comparison with conventional gauges. This flux meter works by convection and not by radiation, and does not allow control of unstationary thermal reactions which are produced in the gas.

Another system is described in the publication DE 2 064 292, in the name of SHOWA DENKO KK, which concerns a thermofluxmeter with a heat conducting plate associated with two high heat-resistant plates placed on either side of the heat conducting plate, as well as two thermocouples mounted on either side of the system. It is in fact a classic auxiliary shell flux meter working by conduction. The response time of this type of instrument is too slow for present unstationary systems in high reactivity gases.

A third system is described in the article by R S Figliola et al “Boundary condition influences on the effective area of a local heat flux probe” which appeared in MEASUREMENT SCIENCE AND TECHNOLOGY, IOP PUBLISHING, Bristol, GB, Vol 7, No. 10 of Oct. 1st, 1996 (1996-10-01) pages 1439-1443, XP000632229 ISSN: 0957-0233 which describes a heat flux sensor which must be mounted on an isothermal body and which functions by convection and not by radiation. The transfer by convection implies a significant reaction time such that the system does not lend itself to the study of rapid phenomena.

Usually, the control of the combustion of propellants is handled by measuring the temperature of combustion gases by means of thermocouples whose thermometer pocket is in contact with the gaseous fluid. However the thermocouple sensors have a relatively long response time and require fairly significant contact time with the gaseous fluid. These devices deteriorate very quickly due to this fact in these highly corrosive gases which are at high pressure and temperature. Besides, with combustion phenomena being highly variable and non-stationary, combustion control tests are of a very short duration and require measuring devices which possesses a low response time. A low time constant solution consists of taking an optical measurement of the temperature through a sapphire window, but the cost of such a device is very high and the window clouds over very rapidly as a result of combustion residue deposits.

In addition to the cost and inadequacy of existing devices, even the principle of gas combustion control by temperature remains inappropriate. In fact, all control systems measure the average gaseous fluid temperature, but temperature is a state quantity and is not representative of the thermokinetics of the combustion gases and the real state of the gases at each instant of combustion. The control of the quantity of heat generated within the combustion gas by the heat flux density magnitude remains the only manner of measuring variable phenomena taking place within the gaseous fluid. Now the phenomena which occur within the gases are rapid phenomena which classical temperature or heat flux measuring systems cannot capture, essentially due to their excessively long response times.

### DESCRIPTION OF THE INVENTION

The goal of the present invention is to reduce the consequences of the problems of the existing devices by the creation of a very low response time device which enables the instantaneous measurement of heat flux density in a highly corrosive gas environment and under extreme temperature and pressure conditions, while limiting excessive heat flux sensor deterioration and the resulting costs.

This goal is attained by a measuring device as previously defined, characterized by the fact that it has a tubular metal body open at its two extremities, a low heat loss isotropic chamber, mounted coaxially within the tubular metal body, a detector of the radiative heat flux, equipped within the interior of the isotropic chamber, this detector being designed to deliver an electrical signal representative of the non-stationary and convective heat flux generated within the gaseous fluid, a metallic lens designed to pump the gaseous fluid heat and irradiate it integrally and instantaneously into the isotropic chamber, this lens being mounted on a cap designed to seal one of the extremities of the tubular metal body, and a plug designed to seal the other extremity of the tubular metal body, a space being provided between the isotropic chamber and the tubular metal body to allow the passage of a purging gas circulating within the isotropic chamber and in the space.

Based on the preferred method of construction, the tubular metal body is provided with a safety vent discharging into the space provided between the isotropic chamber and the tubular metal body and through which the space accesses the exterior to allow the exit of the over-pressured purging gas.

According to this preferred method of construction, the cap is mounted in a removable manner on an extremity of the tubular metal body.

Preferably, the cap has an external thread designed to interact with an interior thread located on one of the extremities of the tubular metal body.

In a particularly advantageous manner, the cap is equipped with a transverse opening in which the metallic lens is mounted in such a way that one of its faces is in contact with the gaseous fluid.

In the preferred production design, the detector and the lateral walls of the isotropic chamber are integral with the plug and the plug is advantageously provided with entry and exit paths for the purging gas.

Preferably, the interior wall of the isotropic chamber is coated with a metallic deposit nap so as to ensure a maximum corpuscular reflection of the radiated heat flux emitted in the chamber.

In this production design, the exterior wall of the isotropic chamber is also coated with a metallic deposit so as to reflect a coaxial parasitic ray emitted by the tubular metal body in the space provided between the isotropic chamber and the tubular metal body.

The isotropic chamber can be of a cylindrical form and the detector is affixed according to the axis of this chamber.

The metallic lens is advantageously a high thermometric conductivity body designed to pump the heat from the heat flux by its face in contact with the gaseous fluid, its other face being designed to instantaneously and integrally radiate the pumped heat flux to the interior of the isotropic chamber.

To this end, the face of the lens in contact with the gaseous fluid can be coated with a metallic oxide deposit with a high coefficient of absorption and resistance to corrosion, the other face being coated with a high emissivity metallic deposit.

The metallic lens is advantageously provided at its periphery with an attachment element by which it is attached in a removable manner to the extremity of the metal body by way of the cap.

In a production variant, the metallic lens can include a circular part by which it pumps the heat flux of the gaseous fluid, and a conical part radiating the heat flux pumped into the isotropic chamber, the two parts being joined together by a small diameter connecting axis.

In this production variant, the circular part of the metallic lens can be of the flat, cylindrical or curved form.

In addition, the conical part of the metallic lens can contain a truncated cavity designed to increase the emitting surface, the conical part being full and rounded.

### SUMMARY DESCRIPTION OF THE DRAWINGS

The present invention and its advantages will be better understood by referring to the detailed description of a preferred example of production, provided for information purposes, and not limiting, and to the attached drawings in which:

FIG. 1 is a sectional schematic view representing the preferred production design of the device according to the invention,

FIG. 2 is a schematic sectional view based on a plane normal to the sectional plane of FIG. 1 and representing the device and its positioning on a support containing the gaseous fluid, during the measuring process.

FIG. 3 is a sectional schematic view of a variant of the heat flux measuring device according to the invention, and

FIGS. 4A, 4B, 4C and 4D schematically represent several forms of the metallic lens of the invention measuring device.

### METHODS OF PRODUCING THE INVENTION

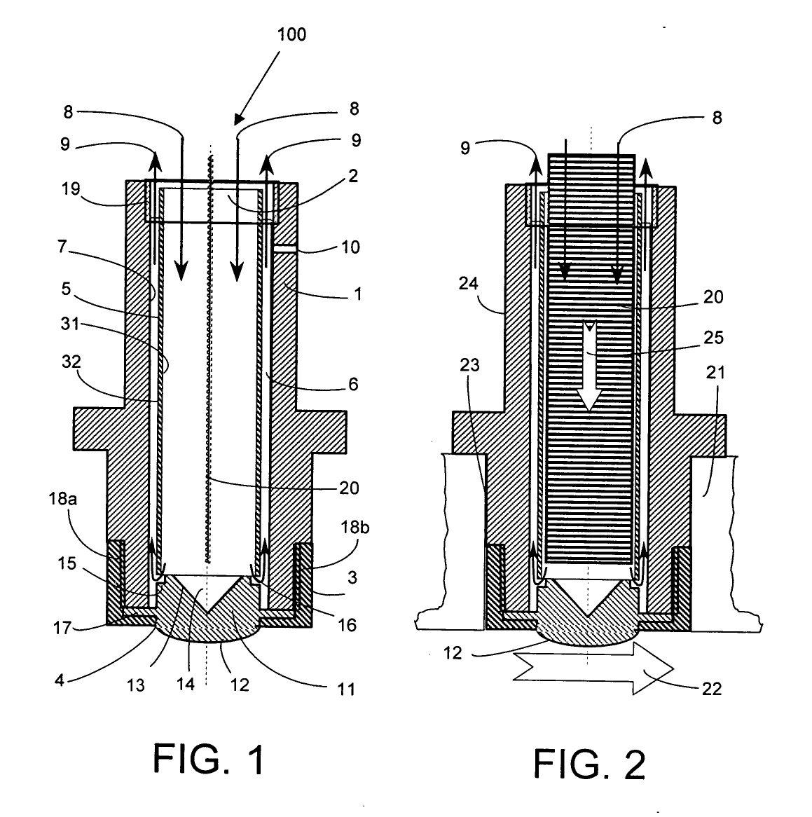

Referring to FIGS. 1 and 2, the non-stationary heat flux measuring device 100 shown consists of a tubular metal body 1 closed at one of its extremities by a plug 2 and at its other extremity by a cap 3 provided with a traversing central opening 4. A radiative measuring isotropic chamber 5, consisting of a hollow cylinder and equipped with a flat, rectangular detector 20, is attached in a coaxial manner to the interior of the tubular metal body 1, one of the extremities of the isotropic chamber 5 being connected to the plug 2 and the other extremity of this chamber remaining open. A cylindrical annular space 6 is provided between the isotropic chamber 5 and the interior wall 7 of the metal body 1 in order to permit the evacuation of a purging gas 25. This purging gas 25 is preferably low-pressure compressed air which is exhausted in the isotropic chamber 5 in order to maintain the temperature of the detector 20 as stable as possible throughout the duration of measurement. To this end, the plug 2 is provided with at least one entrance path 8 for the purging gas 25 and at least one exit path 9 by which this gas is evacuated in the form of a traversing bore, these paths being realized preferably in the form of traversing bores. The tubular metal body 1 is also provided at one of its extremities with at least one small-diameter vent 10 emerging radially from the annular space 6, this vent also permitting the discharge of the purging gas 25. This ventilation avoids the risks of overpressure within the device.

A high thermometric conductivity cylindrical metallic lens 11 is mounted in one of the extremities of the metal body 1 coaxially with this body by being inserted across the opening 4 of the cap 3. This lens 11 has a slightly curved external face 12 which forms a protuberance with respect to the external face of the cap and an internal face 13 with a truncated cavity 14 which opens to the interior of the isotropic chamber 5. The external face 12 of the metallic lens is in contact with the gaseous fluid 22 in which the device is found. The lens 11 is also provided with a flange 17 allowing its installation in a removable manner in the lower extremity of the isotropic chamber 5. To this end, the flange 17 is designed to be inserted against the extremity of the metal body 1. It is maintained in position by the cap 3 which is equipped with an interior thread 18a which operates together with an external thread 18b of the metal body 1 to create a link that can be dismantled. The upper extremity of the lens 11 seals the exit from the isotropic chamber 5 and is equipped with shoulder 15 in order to produce a passage 16 enabling the evacuation of the purging gas. This passage 16 can also be defined by any other means, for example, by the presence of a beveled edge.

Plug 2 seals the upper extremity of the metal body 1 by a threaded connection 19, the body being provided with an internal thread and the corresponding external thread being cut into the external shell of the plug 2. Any other form of connection that can be dismantled can be envisaged.

Detector 20 is installed at the median plane of the isotropic chamber 5 so that one of its extremities is affixed to the plug 2 and crosses through it by several millimeters, and so that the other extremity is slightly shortened in relation to the isotropic chamber 5, the lateral sides of the detector 20 being virtually in contact with the interior wall 31 of the chamber. It is also attached by its lateral sides to the interior wall of the isotropic chamber 5. This attachment can be realized by any appropriate means.

The heat flux measuring device 100 is connected in a removable manner through the intermediary of the tubular metal body 1 to a support 21 containing the gaseous fluid 22 to be controlled. This support can for example be the shell of a reactor or a turbine, in the specific case of the control of gases produced by the combustion of propellants. Part 23 of the metal body 1 which is affixed to the support 21 can have an external diameter which is greater than or less than that of part 24 of the body 1 located outside of the support. The tubular metal body 1 can have any other appropriate form facilitating the mounting of the various device components and its connection to support 21, its axis being perpendicular to the direction of flow of the gaseous fluid 22. With the isotropic chamber 5 possessing the same heat radiation properties in every direction, the orientation of the detector 20 plane with respect to the direction of flow of the gaseous fluid 22 being controlled does not affect the measurements of heat flux. This provides flexibility in connecting the device with a view to measurement.

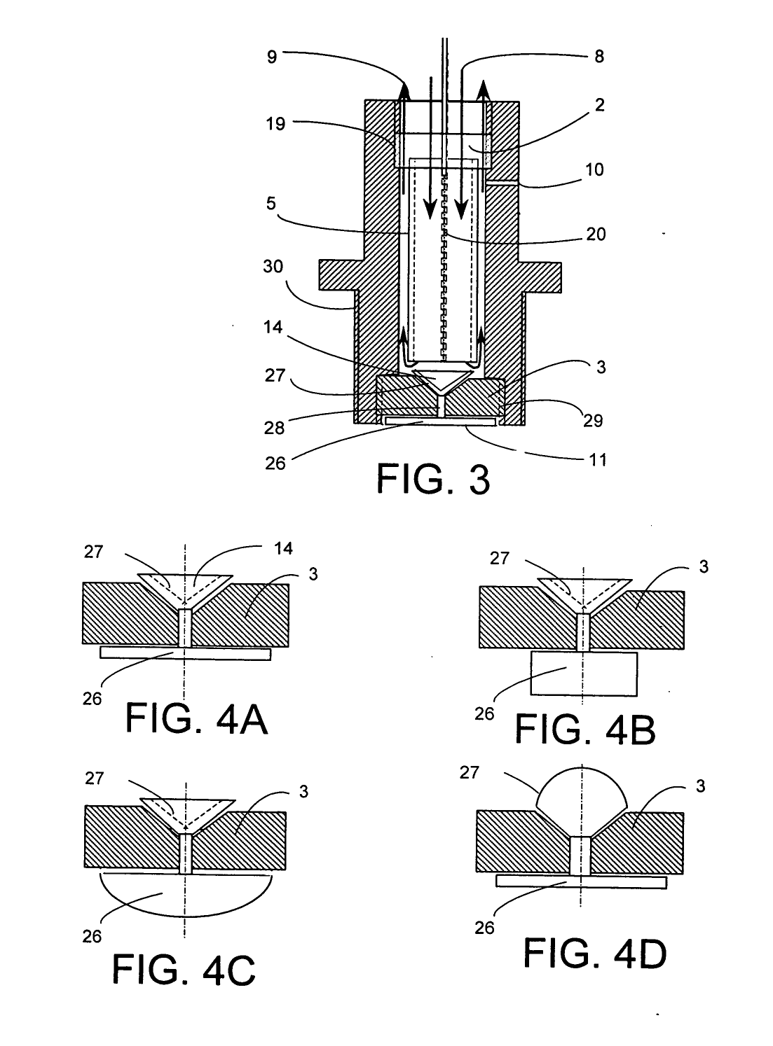

FIG. 3 represents another form of production of the invention device. In this variant, the metallic lens 11 has a significantly different form from that of the lens illustrated in FIGS. 1 and 2. This lens 11 has a circular part 26, through which it pumps by convection and radiation the heat flux of the gaseous fluid 22, and a conical part 27 with a truncated cavity 14 by means of which it radiates the quantity of heat received into the isotropic chamber 5, the two parts 26 and 27 being joined to one another by the intermediary of a connecting axis 28. The lens 11 is connected to the cap 3 by a pivot linkage, this lens-cap subassembly being affixed in a removable manner to the extremity of the metal body 1 by a screwed connection 29, the cap 3 being provided with an external thread and the metal body 1 with a corresponding internal thread. The metal body 1 can be provided with an external thread 30 by which the device is attached to the interior of a corresponding bore (not shown) provided in the gaseous fluid support, the bore being provided with a corresponding interior thread.

The removable lens-cap sub-assembly can be easily replaced when the lens 11 is worn out by the corrosive action of the gaseous fluid or degraded by working conditions. To this end, various forms of lens 11 can be envisaged and can be replaced as a function of the parameters of the gaseous fluid 22, the device being calibrated after each replacement.

FIGS. 4A, 4B, 4C and 4D illustrate several other forms of the metallic lens 11. In these different variants, the circular part 26 of the lens, which is in contact with the gaseous fluid 22 to be controlled, can be of a flat form (FIG. 4A), cylindrical (FIG. 4B) or curved form (FIG. 4C) and the conical part 27 radiating the heat in the isotropic chamber 5 can present a flat form (FIG. 4A to 4C), circular (not shown) or curved form (FIG. 4D). It can also be in the form of a hollow cone (FIG. 4A to 4C) enabling an increase in the emitting surface.

When the device 100 is properly affixed to the support 21 containing a gaseous fluid 22 at high temperature and under high pressure, the quantity of heat generated within the fluid by combustion is pumped by the high thermometric conductivity metallic lens 11 which, under the heat thrust of the surrounding fluid with which it is in contact, tends to impose on the common gas-lens interface 12, a temperature close to the temperature of the lens 11 itself. The temperature discontinuity imposed on the interface being considerable, the gaseous fluid 22 therefore more quickly yields, by convection and by radiation, the quantity of heat to the lens 11. The same is true for the face 13 of the lens 11 in contact with the compressed gas 25 purging the isotropic chamber 5. With convection being very weak in this isotropic chamber, the second face 13 of the lens 11 yields by radiation to the gaseous milieu 25, the quantity of heat received. The detector 20 then delivers an electrical signal proportional to the quantity of heat radiated by the lens 11. This electrical signal is thus proportional to the heat flux density penetrating the lens 11 through its face 12 and is representative of the variability of heat flux generated in the gaseous fluid 22 to be controlled. Preferentially, the purging gas 25—for example, low pressure compressed air—is introduced into the isotropic chamber 5 by entrance way 8; it purges the isotropic chamber 5 and leaves through exit 9 by passing via the annular space 6. This enables the maintenance of the temperature of the detector 20 as stable as possible throughout the duration of the measurement.

The interior wall 31 of the isotropic chamber 5 is advantageously coated with a polished metallic deposit in order to ensure maximum corpuscular reflection of the radiant rays emitted in the chamber. The interior deposit can be realized in gold, according to a known vacuum deposit or similar process. This material presents only a very weak absorption of the radiation emitted. The external shell 32 of the chamber is also coated with the same metallic deposit in order to reflect the parasitic coaxial radiation emitted by the metal body 1 in the annular space 6 which creates a heat barrier tending to reduce the conductive and radiative parasitic flux coming from the body.

In addition, the surface of the lens 11 in contact with the gaseous fluid 22 to be controlled, that is, its external surface 12, and its surface in contact with the purging flux 25, that is, its internal surface 13, can be coated with a black body. To this end, the external surface 12 is coated with a high absorption coefficient metallic oxide in order to improve the resistance of the lens 11 to corrosion, notably, from chlorine, and increase advantageously its life span, and the internal surface 13 is coated with a high emissivity metallic deposit.

The heat flux measuring device 100 is connected during measurement to a processing unit (not shown) by means of electrical cables (not shown). These cables are essentially connected to the electrical circuit of detector 20. When the detector is radiated by a quantity of heat from the lens 11, it delivers to the processing unit an electrical current proportional to the density of the heat flux issuing from the lens 11 and then, to the non-stationary heat flux generated within the gaseous fluid 22 to be controlled. The processing unit can then calculate the heat flux density within the fluid.

The temperature of the gaseous fluid 22 can then be deduced from the value of the heat flux density measured by the Stefan Boltzmann law:
T₀=(f₁₂φ₀₋σ⁻¹+T⁴)^{1/4}

in which T₀ designates the temperature of the lens 11, T the temperature of the radiative flux detector 20, φ₀ the density of the heat flux penetrating the lens, σ is the Boltzmann constant, and f₁₂ is the factor for the device form. This form factor f₁₂ is a calibration factor which takes into account the totality of the influences of the various physical parameters and those of the construction of the device. During calibration, this factor is adjusted until the temperature indicated by the processing unit corresponds to that of the target standard used as a reference.

Based on the measurement of heat flux, the processing unit can also calculate the thermokinetic state indicator of the gaseous fluid 22, the indicator informing in a complete manner on the evolution of combustion. The device according to the invention thus makes available advantageously three key data points on the thermokinetics of the combustion gases, i.e., the heat flux density and the thermokinetic state indicator which are variable quantities, and the temperature which is a state quantity.

The radiant flux detector 20 mounted in the isotropic chamber is not perturbed by the parasitic convective flux generated by the purging gases 25 of the isotropic chamber 5. The detector 20 must preferably be a differential coplanar couple assembly detector. This type of detector is commercially available.

The metallic lens 11 of the heat flux measuring device 100 is preferably fabricated in leather whose thermometric conductivity is very high, that is, in the order of 36.10³ J/(m².c.s^{1/2}). The isotropic chamber 5 according to the preferred production design is 40 mm in length and 5 mm in internal diameter and the lens 11 is 6 mm in diameter with a height of 6 mm.

### INDUSTRIAL APPLICATION POSSIBILITIES

This measuring device can be used for the control of combustion gases and of any process where control is sought of the thermokinetics aspect of thermal or chemical reactions, notably in nozzles and reactors, and fuel cells for the detection of thermal events such as phase changes. The applications are varied and can be extended notably to petrochemical and chemical (processes).

1-18. (canceled)

19. A measuring device for non-stationary radiative and convective heat flux generated in a gaseous fluid (22), notably a highly corrosive gaseous fluid under high pressure and at high temperature, such as a gas from the combustion of propellants, the device comprising a tubular metal body (1) open at two extremities, a low heat-loss isotropic chamber (5) mounted coaxially in an interior of the tubular metal body (1), a detector (20) of the radiative heat flux, fixed within the interior of the isotropic chamber (5), the detector being equipped to deliver an electrical signal representative of the non-stationary radiative and convective heat flux generated within the gaseous fluid (22), a metallic lens (11) designed to pump heat of the gaseous fluid (22) and radiate the heat integrally and instantaneously into the isotropic chamber (5), the lens being mounted on a cap (3) designed to seal one of the two extremities of the tubular metal body (1) and a plug (2) designed to seal a first of the two extremities of the tubular metal body (1), an annular cylindrical space (6) located between the isotropic chamber (5) and the tubular metal body (1) to permit passage of a purging gas (25) circulating in the isotropic chamber (5) and in the annular cylindrical space (6).

20. The measuring device according to claim 19, wherein the tubular metal body (1) is equipped with a safety vent (10) discharging into the annular cylindrical space (6) created between the isotropic chamber and the tubular metal body and through which the annular cylindrical space (6) is linked to an exterior to enable discharge of the purging gas (25) in event of over-pressure.

21. The measuring device according to claim 19, wherein the cap (3) is mounted in a removable manner on one extremity of the tubular metal body (1).

22. The measuring device according to claim 21, wherein the cap (3) has a threaded exterior (18a) designed to operate with an internal thread (18b) cut into one of the two extremities of the tubular metal body (1).

23. The measuring device according to claim 19, wherein the cap (3) is equipped with a transverse opening (4) in which the metallic lens (11) is mounted in a manner that one of its faces (12, 13) is in contact with the gaseous fluid (22).

24. The measuring device according to claim 19, wherein the detector (20) is affixed to the plug (2).

25. The measuring device according to claim 19, wherein the lateral walls of the isotropic chamber (5) are affixed to the plug (2).

26. The measuring device according to claim 19, wherein the plug (2) is provided with entry ways (8) and exit ways (9) for the purging gas (25).

27. The measuring device according to claim 19, wherein an interior wall (31) of the isotropic chamber (5) is coated with a metallic deposit nap so as to ensure a maximum corpuscular reflection of the radiated heat flux emitted in the chamber (5).

28. The measuring device according to claim 19, wherein an external wall (32) of the isotropic chamber (5) is also coated with a metallic deposit so as to reflect parasitic radiation emitted by the tubular metal body (1) in the annular space(6).

29. The measuring device according to claim 19, wherein the isotropic chamber (5) is in a cylindrical form and that the detector (20) is affixed according to an axis of the isotropic chamber (5).

30. The measuring device according to claim 19, wherein the metallic lens (11) is a high thermometric conductivity body designed to pump the heat flux heat via a face (12) in contact with the gaseous fluid (22), an other face (13) being equipped to instantaneously and integrally radiate the heat flux pumped into an interior of the isotropic chamber (5).

31. The measuring device according to claim 30, wherein the face (12) of the lens (11) in contact with the gaseous fluid (22) is coated with a metallic oxide deposit with a high absorption coefficient and resistance to corrosion, the other face (13) being coated with a high emissivity metallic deposit.

32. The measuring device according to claim 19, wherein the metallic lens (11) is provided at a periphery with an attachment element (17) by which the lens is attached in a removable manner to one of the two extremities of the metal body (1) by means of the cap (3).

33. The measuring device according to claim 30, wherein the metallic lens (11) has a circular part (26) through which the heat flux of the gaseous fluid (22) is pumped and a conical part (27) radiating the heat flux pumped into the isotropic chamber (5), the circular and conical parts (26 and 27) being connected to one another by a small diameter liaison axis (28).

34. The measuring device according to claim 33, wherein the circular part (26) of the metallic lens (11) has on of a flat, cylindrical or curved form.

35. The measuring device according to claim 33, wherein the conical part (27) of the metallic lens (11) includes a truncated cavity (14) designed to increase an emitting surface.

36. The measuring device according to claim 33, wherein the conical part (27) of the metallic lens (11) is full and curved.
